(19) United States
(12) Patent Application Publication
(10) Pub. No.: US 2006/0244288 A1
(43) Pub. Date: Nov. 2, 2006

(54) System for refilling a fluid reservoir

(76) Inventors: Chain S. Sandhu, Northville, MI (US); Hugo Magi, Bloomfield Hills, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/415,675

(22) Filed: May 2, 2006

Related U.S. Application Data
(60) Provisional application No. 60/676,840, filed on May 2, 2005.

(51) Int. Cl. B62D 25/08

(52) U.S. Cl. 296/192

(57) ABSTRACT

A system for refilling a fluid is described having an orifice disposed proximate an exterior surface of a vehicle being in fluid communication with a fluid reservoir. The fluid reservoir is disposed below the exterior surface of the vehicle whereby the orifice may be accessed without opening a hood of the vehicle.

### CROSS-REFERENCE To RELATED APPLICATIONS

This application claims the benefit of U.S. Provisional Application Ser. No. 60/676,840 filed May 2, 2005, which is hereby incorporated by reference in its entirety.

### TECHNICAL FIELD

Described herein is a refilling system, and more particularly, the refilling system illustrated is directed to an innovative system for refilling a fluid reservoir.

### BACKGROUND

Automotive vehicle bodies usually have a gap between the back wall of the engine compartment and the lower edge of the windshield. This gap is bridged by a part that is referred to variously as a cowl, cowl grille, cowl panel, beauty panel, or leaf screen, and hereinafter called a cowl. The cowl is secured along its lower edge to the body wall and along its upper edge to, or near, the lower edge of the windshield, and may be partially covered itself by the rear edge of the hood, especially in designs with hidden windshield wipers.

Typically, the cowl is a single sheet structure to which is fixed a bearing housing that provides a sleeve bearing for a pivot shaft of a wiper arm. With such an arrangement, the pivot shaft must be passed through the bearing housing first, and the wiper arm completed afterward by attaching a crank arm to the lower end of the pivot shaft and a blade support to the upper end of the pivot shaft.

Another known cowl and wiper arm assembly provides the structural stiffness of a shell, having two layers or panels flanged together along their peripheral edges. The shell is specially configured to create areas of increased stiffness that allows a wiper arm of the integral type to be passed through the shell and also allows it to be pivoted relatively to the shell. Further, the shell is made as a plastic blow-molded structure that provides a leak-proof fluid reservoir with no additional structure. Given its proximity to the windshield, it is desirable to adapt the cowl to provide a convenient foundation for an orifice to refill a fluid reservoir, the fluid reservoir being disposed below the cowl or integrated within the cowl.

### SUMMARY

In the illustrative embodiment, a system and method for refilling a fluid is employed in which an orifice disposed proximate an exterior surface of a vehicle is in fluid communication with a fluid reservoir. The fluid reservoir is disposed below the exterior surface of the vehicle, whereby the orifice may be accessed without opening a hood of the vehicle.

### BRIEF DESCRIPTION OF THE DRAWINGS

The features and inventive aspects of the present invention will become more apparent from the following detailed description, the appended claims, and the accompanying drawings, of which the following is a brief description:

FIG. 1 is a partial perspective view of a vehicle having a first embodiment of a system for refilling a fluid reservoir and showing a cap disposed within a cowl grille;

FIG. 2 is a cross-sectional view of the system of FIG. 1 taken along section line 2-2 of FIG. 1;

FIG. 3 is a cross-sectional view of a second embodiment of a system for refilling a fluid reservoir having a cap disposed beneath a cover; and

FIG. 4 is a cross-sectional view of a third embodiment of a system for refilling a fluid reservoir, illustrating a fluid reservoir integrated with a cowl grille.

### DETAILED DESCRIPTION

Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limiting or restricting to the precise form and configuration shown in the drawings and disclosed in the following detailed description.

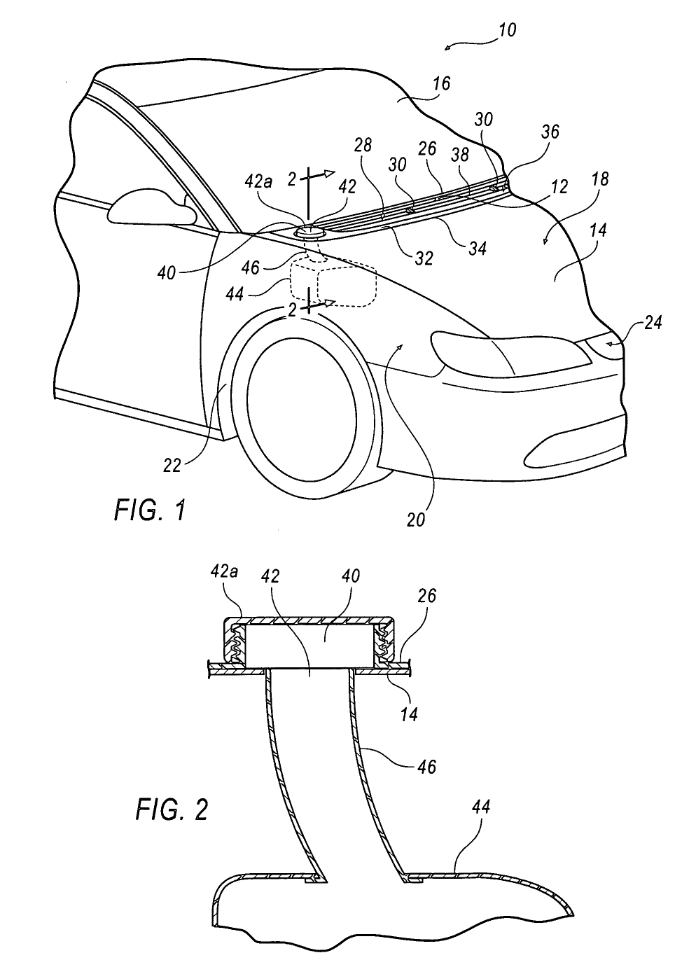

Referring to FIG. 1, a portion of a vehicle 10 is illustrated. The vehicle 10 includes a cowl grille 12 disposed between a vehicle hood 14 and a windshield 16 that define a portion of a vehicle exterior surface 18 of a vehicle engine compartment (not shown). In one example, the engine compartment may be located in the front of the vehicle 10. In yet another example, the engine compartment may be located in the rear of the vehicle 10. In the illustrated embodiment of FIG. 1, the engine compartment is disposed in the front of the vehicle 10 and is defined by a right front quarter panel 20 having a wheel opening 22, the cowl grille 12, the hood 14, a front grille structure 24, and a left front quarter panel (not shown). The cowl grille 12 extends laterally across generally the entire width of the vehicle 10. However, any shape and size of the cowl grille 12 is contemplated.

The cowl grille 12 may be formed in an injection molding operation from a suitable plastic material or may be formed from any metal. The cowl grille 12 includes a main body portion 26 having a planar leaf screen portion 28, a washer fluid channel (not shown) extending along the main body portion 26 and molded integrally therewith, and windshield washer nozzle members 30 formed integrally with or secured to the main body portion 26. The nozzle members 30 may also be integrated with the windshield wipers (not shown).

The leaf screen portion 28 includes a forward flange portion 32 positioned beneath the rear edge 34 of the closed hood 14 and a plurality of parallel grille openings 36 defined between a plurality of ribs 38 and functioning in a known manner to allow the entry of fresh air into the vehicle 10.

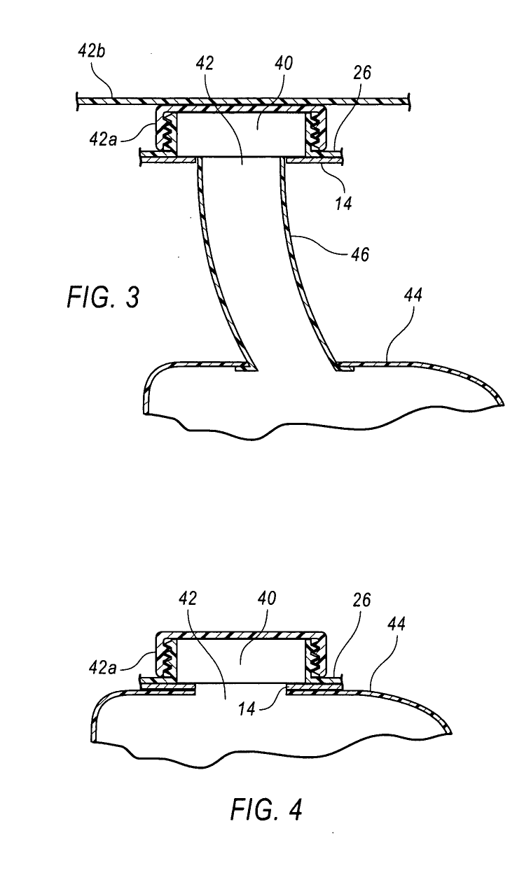

Referring to FIGS. 1 and 2, an entry end 40 having an orifice 42 is disposed along the exterior surface 18 of the vehicle 10, allowing a user to refill a reservoir 44 disposed beneath the hood 14 without having to open the hood 14 and access the engine compartment. The orifice 14 may be covered and secured by any known method available in the art. It is understood that one skilled in the art will recognize the many closure devices and methods that exist for closing the orifice 42, including a cap 42a that may be secured to the orifice in any manner and including a screw-type cap 42a as shown. Further, the cap 42a may be disposed beneath a panel portion 42b of the cowl grille 12 as illustrated in FIG. 3. The panel portion 42b may be selectively lifted to gain access to the orifice 14. Although the cowl grille 12 has been illustrated as being formed in a single piece extending laterally across generally the entire width of the vehicle 10, it will be understood that in certain applications the cowl grille 12 may be formed as a multipart structure with the structures suitably mechanically joined together to form the total cowl grille assembly (not shown).

By way of example, a short flexible hose 46 of elastomeric material interconnects the entry end 40 with the reservoir 44 positioned beneath the hood 14 of the vehicle 10, as described above, in a known manner.

In one embodiment, the fluid reservoir 44 is a windshield washer reservoir. Further, the reservoir 44 may also be integrated with the cowl grille 12, as illustrated in FIG. 4, having the entry end 40 disposed proximate an upper surface of the cowl grille 12. The fluid reservoir 44 responds to the user's actuation of a suitable control device within the passenger compartment of the vehicle 10, and washer fluid is routed to the nozzles 30 from which the fluid may be sprayed onto the windshield 16 in a known manner as laterally spaced streams make contact with the windshield wipers (not shown) in an equally known manner to clean the windshield 16.

In the filling operation, the user opens the area where the orifice 42 is located from the outside of the vehicle 10 without opening the hood 14. A fluid is then poured into the orifice 42 permitting the fluid to travel along the fluid refill hose 40 into the fluid reservoir 44. An advantage of this method of refilling the fluid reservoir 44 is that the user does not need to gain access to the engine compartment. The described method also provides a more efficient way of refilling the fluid reservoir 44 without the user getting dirty.

A method for refilling a windshield washer fluid includes providing the orifice 42 disposed proximate the exterior surface 18 of the vehicle 10 or vehicle component; and placing a windshield washer fluid reservoir 44 in fluid communication with the orifice 42, the windshield washer fluid reservoir 44 being disposed below the exterior surface 18; whereby the orifice 42 may be accessed without opening the hood 14 of the vehicle 10. The described method may also include installing the hose 46 between the orifice 42 and the windshield washer fluid reservoir 44 and selectively securing the cap 42a covering the orifice 42.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. A system for refilling a fluid comprising:
an orifice disposed proximate an exterior surface of a vehicle component; and
a fluid reservoir in fluid communication with said orifice, said fluid reservoir being disposed below said exterior surface;
whereby said orifice may be accessed without opening a hood of said vehicle.

2. The system of claim 1, wherein said fluid reservoir is a windshield fluid reservoir.

3. The system of claim 1, wherein said fluid reservoir is a coolant fluid reservoir.

4. The system of claim 1, including a component defining said orifice disposed above the exterior surface.

5. The system of claim 1, including a component defining said orifice disposed below said exterior surface.

6. The system of claim 1, wherein said exterior surface is a cowl grille exterior surface.

7. The system of claim 1, wherein said exterior surface is a vehicle panel exterior surface.

8. The system of claim 1, wherein said exterior surface is proximate a front portion of said vehicle.

9. The system of claim 1, wherein said exterior surface is proximate a rear portion of said vehicle.

10. The system of claim 1, further including a hose disposed between said orifice and said fluid reservoir.

11. The system of claim 1, wherein said fluid reservoir is integral with said cowl grille.

12. The system of claim 1, wherein said orifice is in mechanical communication with a closure mechanism.

13. The system of claim 1, including a component defining said orifice disposed below a closure mechanism.

14. A system for refilling a windshield fluid comprising:
an orifice disposed proximate an exterior surface of a vehicle;
a windshield washer fluid reservoir in fluid communication with said orifice, said windshield washer fluid reservoir being disposed below said exterior surface; and
a hose disposed between said orifice and said windshield washer fluid reservoir having a first end proximate said orifice and a second end in communication with said windshield washer fluid reservoir;
whereby said orifice may be accessed without opening a hood of said vehicle.

15. The system of claim 14, wherein said windshield fluid reservoir is integral with said cowl grille.

16. The system of claim 14, wherein said orifice is in mechanical communication with a closure mechanism.

17. The system of claim 14, including a component defining said orifice disposed below a closure mechanism.

18. A method for refilling a windshield washer fluid comprising:
providing an orifice disposed proximate an exterior surface of a vehicle component; and
placing a windshield washer fluid reservoir in fluid communication with said orifice, said windshield washer fluid reservoir being disposed below said exterior surface;
whereby said orifice may be accessed without opening a hood of said vehicle.

19. The method of claim 18, further including installing a hose between said orifice and said windshield washer fluid reservoir.

20. The method of claim 18, further including selectively securing a cap covering said orifice.
